(19) United States
(12) Patent Application Publication
(10) Pub. No.: US 2016/0012862 A1
(43) Pub. Date: Jan. 14, 2016

(54) Point of Sale Product-Activated Video Display and Method

(71) Applicant: Donn K. Harms, Del Mar, CA (US)

(72) Inventor: Donn K. Harms, Del Mar, CA (US)

(21) Appl. No.: 14/796,879

(22) Filed: Jul. 10, 2015

Related U.S. Application Data
(60) Provisional application No. 62/023,091, filed on Jul. 10, 2014.

(51) Int. Cl. G11B 33/06; G11B 31/00; H04N 5/225; H04N 5/775

(52) U.S. Cl. CPC G11B 33/06; H04N 5/775; G11B 31/00; H04N 5/2252

(57) ABSTRACT

A video display employable for advertising and method of formation thereof is disclosed. The video display is customizable with removably engageable housings formed from planar substrates. Decorative or advertising indicia is impartable to the planar substrates which are configured to be folded to form a housing in which a media player is removably engaged. The housing and indicia thereon is easily changed by removing the media player from a first housing and engaging with a subsequent housing.

This application claims the benefit of U.S. Provisional Application No. 62/023,091 filed on Jul. 10, 2014. The device and method herein concerns point of sale and advertisement video sales inducements. More particularly, the device and method provide for employment of product-activated point of sale media players, for the provision of product or service information to users or buyers who activate the device through movement or touching the product, or opening the indicia-covered front cover. The device preferably employs a housing which is sufficiently flexible to allow printing of indicia thereon which allows for the recycling of the media player once removed from the recyclable housing.

### FIELD OF THE INVENTION

### Background of the Invention

Media playing devices have been employed to display videos and photos for many years. Most have evolved, in the portable mode, to include a display formed of an LCD display which is operatively engaged to a computing device with onboard memory, housed within a hardened case. Videos and photos and other indicia may be stored to electronic memory on such devices and later depicted on the video display. Such is accomplished using software running on an onboard computing device which is configured to convert media files stored in electronic memory, into viewable video photos and movies and other indicia or media on the video display. Conventionally such devices are generally user-owned and intentionally user-activated to display known media or intended media on the video display.

Such video playing devices and capability are included in smartphones, pad computers, dedicated video players, and modern televisions and gaming devices. However, all of these devices include expensive additional components, and hard protective housings or surrounding cases, and generally include the action of video and photo depiction upon a video display, as only one of many functions performed by the device itself. Any of the many computerized functions on conventional devices must be intentionally activated by the owner or user to display the media or indicia of choice to a viewing user. With such hardened cases, and software and components providing multiple uses requiring expensive electronics, such devices are inherently expensive.

Consequently, such conventional computing devices with video display capability, are not well adapted or configured to simply provide video, audio, and photo depiction and playback, of media concerning a single event, purpose or reason. Further, even if such devices were to be employed for instance to provide video depiction in conjunction with an event, product, or service, such is extremely costly due to the hard cases and internal electronics providing multiple functions. Additionally, the deployment of conventional multi-functional devices for singular purposes, such as point of sale displays and product literature is wasteful as well as overly expensive. This is because conventional media-capable devices with permanent fitted hard cases configured to surround integrated electronics which provide multiple computing purposes, are not well adapted to provide buyers a video and audio experience concerning a single product or service at a point of sale, or for instance through the mail.

As such, there exists an unmet need, for a device and method providing a media component for video display and sound from electronic files in onboard electronic memory, such as videos and slide shows of photos and other indicia and the like. Such a device should be easily activated by user-action elicited by or related to a single product, service, person, event, venue, or other singular matter or event. Such a device should include a processor and electronic memory operatively engaged with video display and audio, providing a media player which self-activates upon a user action such as picking up a product, moving a distance from or proximate to the media player, or most preferably, opening a disposable or recyclable indicia-covered cover, enticing such action.

Such a device and method, however, in a preferred mode, should employ a media player which has a housing conforms to surround the media player, which is easily customizable with indicia thereon. In such fashion the indicia may be imparted to the housing while in a planar configuration, whereupon the housing may be folded to a configuration to engage as a housing with the media player. In this fashion, one or a plurality of media players can be employed and moved between formed housings having indicia thereon related to the subject matter of the media to be displayed on the video display. Such allows for local printing of the indicia to the housing while in a planar configuration, and subsequent formation and engagement as a housing to the media player and related components therefor.

Formed of paper or paper board or recyclable plastic, which can be stocked in a planar printable fashion, and folded for operative engagement as a housing for media players, such a device and method would also facilitate small businesses as well as large, to position indicia upon the disposable housing and/or products themselves, which will elicit a viewer response which activates the media player within the customized recyclable housing. Each media player prior to engagement with a customized housing, may be programmed with electronic files which are employable by onboard software to display video and reproduce audio on the media player concerning the product, service, venue, event, or matter to which the product or indicia printed to the engageable cover eliciting the user-activation pertains.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

One object of the instant invention is to provide a device and method for providing a media player with a video display and sound, having onboard memory and computer video processing, in a form which is engageable with any of a plurality of housings having indicia thereon adapted to elicit a user activation to play the video.

Another object of this invention is to provide such a media player as part of a point of sale, or provided advertisement, for a service or product, or venue, or intangible being advertised by a provider.

An additional object of this invention is the provision of a media player adapted for engagement to a housing or cover formed from a planar substrate of disposable or recyclable material, subsequent to local printing of indicia upon the substrate, thereby facilitating the employment of media for sales by small business and individuals using electronic printing devices to impart indicia to the housings.

A further object of this invention is to provide a point of sale advertising device and method which employs a media player having a video display and/or audio, which is activated by the user moving a product or object from a defined proximity to the media player housing.

An additional object of this invention is the provision of a media player, having a housing formed of a folded planar substrate which is imprintable locally with indicia adapted to elicit a user response to activate the media player, in the customized housing.

Yet another object of the invention is the provision of a device and method for the configuration of custom imprinted removably engageable housings which will fit upon any of a plurality of media players adapted to engage the housing formed from a folded planar substrate.

These and other objects and advantages will become obvious to those skilled in the art when taken into consideration with the following drawings and specifications.

These and other objects, features, and advantages of the present device and method, as well as the advantages thereof over existing prior art, which will become apparent from the description to follow, are accomplished by the improvements described in this specification and hereinafter described in the following detailed description which fully discloses the invention, but should not be considered as placing limitations thereon.

### SUMMARY OF THE INVENTION

In accordance with the purposes of the disclosed device and method as embodied and broadly described herein, the present invention provides a device and method for the display of media files, such as photos and videos and indicia, on a media player having electronic memory and software adapted to display digitally stored indicia on the video display.

In all modes of the device enabling the method herein, it is preferable that the device includes electronic components and digital memory to both store the digital media, and operate a video display screen operatively engaged within the customizable recyclable housing. Further preferred is having the media player having buttons or other means to activate the media player to play the digital media, through an action by the user. User action to activate the device can be encouraged by using the product which is the subject matter of the digital media stored on the media player, for activation thereof. Also preferred is printing or placing indicia on the planar substrate which may be easily formed to a housing having the indicia relating to a product or service, on the exterior of the housing and configured to induce the user to activate the display.

In a preferred mode, the device has one or a plurality of media players are configured to register with and engage with, a housing formed to surround it. In operative engagement within the surrounding housing, a button or touch activation means to activate the video screen of the media player subsequent to an action by the viewer is provided. In one mode, an action by the user to pick up a product located on the housing, or proximate to the media player and housing will activate the media player to display video and/or emit sound. In another mode, activation is accomplished by the viewer opening a cover which has been imprinted with indicia inducing such an opening and the media player is activated to play the stored digital media on the video display.

For example, a product such as a pen or a product package can be positioned on or proximate to the media player. A proximity sensor operatively engaged to the computing device having activation software housed in the media player, causes an activation of the video display, to play the media files stored in memory, when the viewer picks up or moves the product or package a distance away from the proximity sensor in the media player.

The proximity player can be a weight sensor, a magnet, an RFID engaged to the product or package, a light sensor which senses being uncovered when the product or package is moved, or other means to activate the video display to play the media files, when the product is moved from a position. In this fashion, the viewer is induced to start the video display to play the media files, by the placement of the product or package on or proximate to the media player in a natural reaction to an interest in such. They, thus, are induced to start the media player to play the stored movies, pictures, or other indicia, on the video screen, using the product or product packaging itself to do so.

In modes of the device where the product is engaged with the housing, a positioning area can be marked on the housing, adjacent the video screen, to give the viewer a target to replace the product or package when done viewing.

In modes of the device and method where activation is accomplished by the viewer opening a cover, it is preferable that the outside surface of the cover, covering the video display, has indicia thereon inducing them to open the cover and initiate the media player to display stored digital videos, photos, or other indicia, upon the video screen. This may be accomplished more easily if the housing, or portions of it, can be printed locally on a conventional inkjet or laser printer and engaged to the device with the indicia having been applied locally. Such a mode will allow small businesses and individuals to produce video players to use in conjunction with their products and services and easily change the indicia used by simply using a new templet to print or apply new indicia to the housing of the media player.

Of course the mode employing a printable templet can be used with either the product activated mode of the device, or the cover activated mode, and provide both small and large businesses the ability to provide video information and advertising concerning their products and services, with housings and covers having related indicia to induce interest to viewers in the product or service.

In preferred modes of the device and method employ a printable substrate configured for a registered engagement with the media player within a formed cavity when the substrate is folded and fixed. This allows any of a plurality of media players adapted for this registered engagement, to be positioned operatively within the formed cavity, within a removable housing having indicia thereon.

Such a system allows for many different and sequential uses of the kit of media players, with respective formed housings. Additionally, the system allows for recycling of the housing, and subsequent reuse of the media player in a new housing. The digital media player and electronic memory and operative electronic components and power, therefor, along with controls and software are operatively engaged with the media player, which is sized and configured for a registered engagement within the formed housing. Such allows for apertures in the media player to align with openings in the formed housing for use while the media player is in registered engagement within the formed housing from the planar substrate.

The substrate formable to the indicia-laden housing is preferably formed of flexible material such as paper, paperboard, cardboard, or plastic which is sized to be folded for engagement to the media player, but may be later disengaged from the media player. The housing has an opening adapted for a registered engagement to surround the video display of the media player once it is placed in registered engagement within the cavity of the substrate-formed housing. In this fashion viewing of the video display of the media player through the opening in the housing is assured.

The media player is configured for a registered engagement within the cavity formed by the folded substrate defining the housing. Such can be using an appropriate releasable attachment of the media player with the housing such as hook and loop fabric, or adhesive, or a biased engagement within the cavity defined by the folded substrate.

The cavity within the folded substrate is maintained preferably by adhesive areas pre-positioned on the substrate to adhere to the substrate surface when folded, however tabs formed into the substrate for engagement into slots formed into the substrate, or other attachments to hold the substrate folded and surrounding the media player may be employed.

As noted, it is preferable that the housing itself be formed of a pre-configured planar substrate, which may be formed of one or a combination of materials such as paper or flexible plastic, or paperboard, or cardboard or other substrate materials as may occur to those skilled in the art which is foldable to form the housing and which may be printed upon or otherwise have indicia imparted to it. The planar substrate should be creased so as to be easily subsequently formed to yield the housing with the internal cavity configured for registered engagement with the media player. Being formed of plastic or paper material, the housing as noted may be customized to the task at hand, and later removed from the media player and recycled.

With respect to the above description, before explaining at least one preferred embodiment of the herein disclosed product activated media player invention in detail, it is to be understood that the invention is not limited in its application to the details of construction and to the arrangement of the components in the following description or illustrated in the drawings. The device and method herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other albums or books having covers including media players and customized indicia adjacent or surrounding the display. It is important, therefore, that the claims be regarded as including such equivalent construction and methodology insofar as they do not depart from the spirit and scope of the present invention.

### BRIEF DESCRIPTION OF DRAWING FIGURES

The accompanying drawings, which are incorporated herein and form a part of the specification, illustrate some, but not the only nor exclusive examples of embodiments and/or features of the disclosed device. It is intended that the embodiments and figures disclosed herein are to be considered illustrative of the invention herein, rather than limiting in any fashion.

In the drawings:

FIG. 1 depicts a top view of the device of the system herein, using a product such as a pen providing means to activate the video display of the media player once within a housing as it is moved from a location on the housing.

FIG. 2 shows an internal view of a housing-engageable media player having electronic memory and wireless or wired means to communicate digital media to that memory for use by the onboard CPU and onboard software which is configured to display movies, pictures, or indicia on the video display screen using the digital media in memory.

FIG. 3 depicts a mode of the device wherein the media player is in registered engagement within the housing formed of a folded planar substrate and has a video display activated by distancing a product package from a resting position on the housing which is marked with indicia during formation, to provide a target for easy replacement by a viewer.

FIG. 3A shows a mode of the device having a cover which when opened will activate the media player to generate video on the video display much the same as the device as shown in FIG. 10.

FIG. 4 shows a mode of the device and system herein showing the planar substrate pre-configured to be folded along creases or the like, to form the housing, and which may be printed or otherwise imparted with indicia to induce the viewer to open it and activate the video screen playing of digital media files stored in memory, and showing the media player ready to be surrounded and held in registered positioning by biasing tabs defining registering fasteners.

FIG. 5 depicts a mode of the device wherein the housing is formed of sufficiently flexible substrate material which is adapted for printing on an inkjet or laser printer and also showing registering fasteners which are cooperative between the media player and the substrate.

FIG. 6 depicts the device and system herein using the planar substrate being printed with customized indicia and the registering fastener of the media player to the substrate being a recess formed in the substrate sized substantially the same as the perimeter of a media player to be engaged.

FIG. 7 shows the media player ready for engagement into the recess defining the registering fastener whereafter the planar substrate will be folded to form the cavity to hold the player.

FIG. 8 shows the planar substrate configured for folding to form the housing having with an internal cavity for a media player and showing indicia imparted thereto by a printing device whereafter the planar substrate is engageable to any of the media players in a registered positioned engagement using the registering fastener.

FIG. 9 shows a housing which includes a foldable cover portion folded against the surface of the assembled housing having the opening for the video display and also depicting customized indicia thereon from the process of FIG. 6.

FIG. 10 depicts the device of FIG. 7 wherein the cover has been opened as an activation of the media player within the cavity of the housing formed by the planar substrate, and showing indicia located on the housing from the process of FIG. 6.

### DETAILED DESCRIPTION OF THE INVENTION

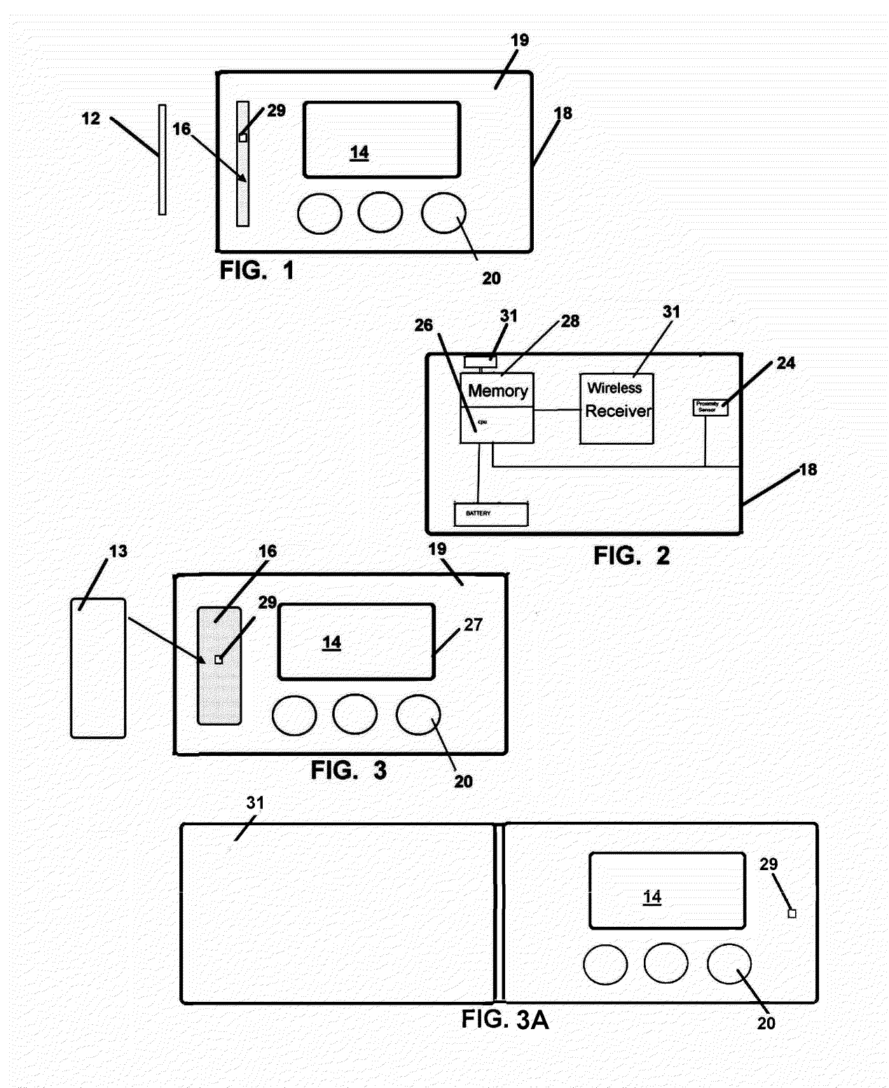

Now referring to drawings in FIGS. 1-10, wherein similar components are identified by like reference numerals, there is scene the device 10 which may be employed in the method herein.

As seen in the overhead view of the device 10 of FIG. 1, a product, 12 such as a pen, or any other product sized to rest on or adjacent to the device 10, is a preferred means to activate the video display 14 once moved from a resting location 16 on the housing 19. Additional user-activated controls 20 are optionally provided if desirable and can be engaged with the housing 19 and in communication with the media player or be part of the media player being engaged to a housing 19.

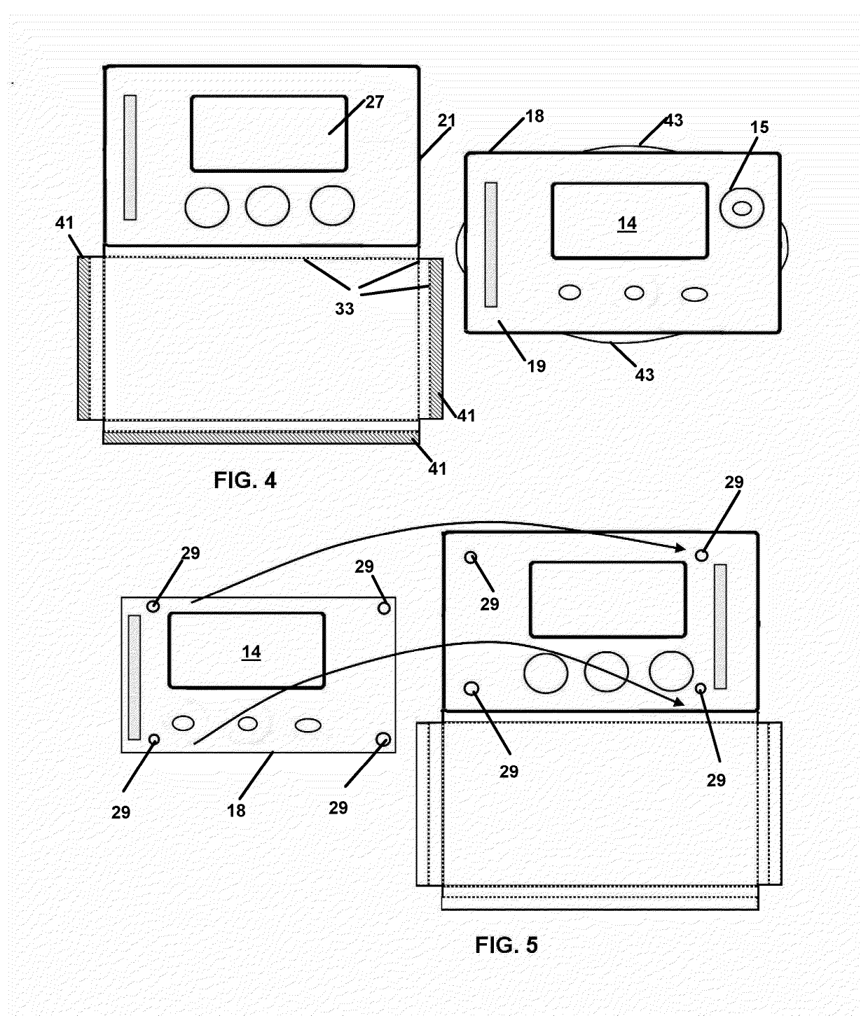

While the media player 18 can be referred to as the combination of the housing 19 and video display 14, it is more preferable that the media player 18 be self contained such as in FIGS. 4-5 where the media player 18 is placed in a registered engagement within a recess or adhesive engagement area 36 formed upon a surface of the substrate 21 defining the interior cavity of the housing 19.

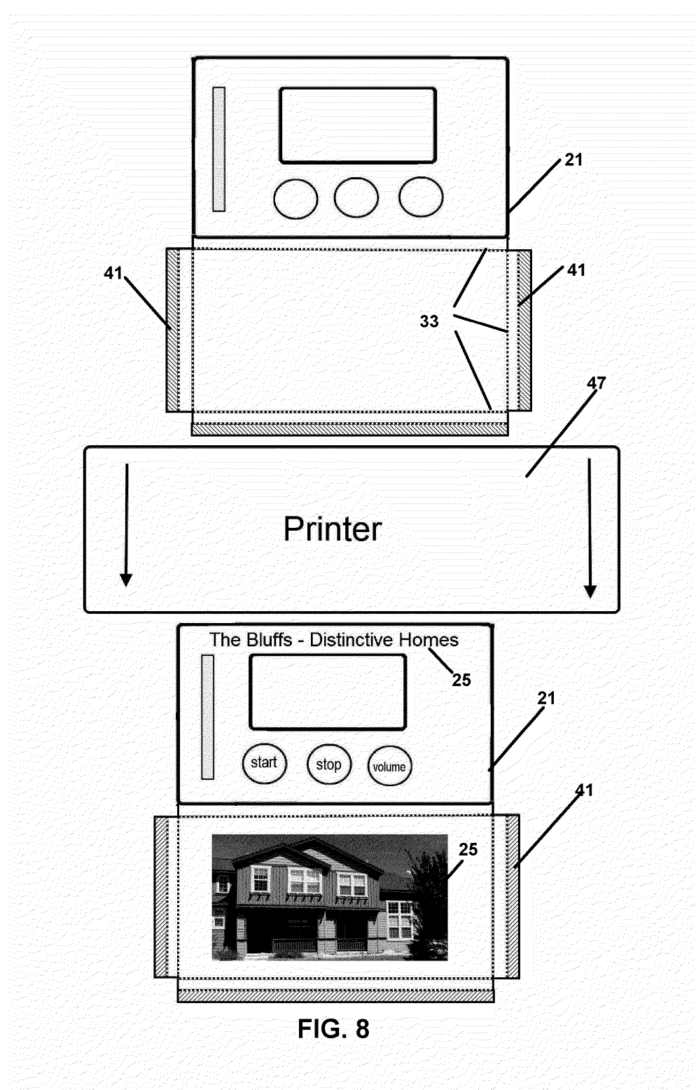

The underlying media player 18 within the formed cavity can be operatively engaged with control areas 20 on the formed housing such as in FIG. 1, or have onboard digital controls if desired. Such operative engagement can be placing player controls 23 adjacent marked control areas 20 of the housing 19 so that when touched by a user, the player controls 23 are activated to perform the desired function such as the functions shown in FIG. 8.

As noted, either opening a cover 31, or moving a product or object, can be the means to signal a sensor 24 operatively engaged in communication with the media player 18 or the CPU 26 (FIG. 2) thereof, whereby software running in memory of the media player 18, is adapted to initiate an activation of the video display 14. Once activated, the video display 14 will play video generated from the electronic media files stored in memory 28 or streamed to the media player 18 by a wireless connection, and audio may be produced through the speaker 15. Thus, when the user picks up or moves the product 12 or package 13 (FIG. 3) a distance away from the housing 19, or opens the cover 31, or touches a control surface 20, the media player 18 is activated to run the software thereon to generate video to the video display 14 and may also generate audio through a loudspeaker 15. The sensor 16 can be a weight sensor, a magnetic sensor of metal in the product 12 or package 13, an RFID engaged to the product 12 or package 13, a light sensor which senses being uncovered when the product 12 or package 13 is moved, an accelerometer engaged with a bluetooth or RF transmitter for sensing and communicating movement with a small transmitter in the product 12 or package 13 in communication with a receiver 31 on the media player 18, or, other to signal and activate the media player 18 to initiate the video display 14 to play the media files, when the product is moved from the resting position 16 or from a position proximate to the media player 18, or the lid closed or the housing 19 touched. In this fashion, the user or viewer of the device 10 is induced to start the display of video on the video display 14 generated from the media files by the removal of the product 12 or package 13 on or proximate to the media player 18 in a natural reaction to an interest in such or can touch the device to initiate it.

Depicted in FIG. 2, as an example of a self-contained media player 18 is shown a typical internal view of a housing-engageable media player 18, having electronic memory 28 and wireless or wired input 31 to communicate digital media files to memory 28 for use by the CPU 26 and onboard software to display movies, pictures, or indicia on the video display screen 14 and create sound on a speaker 15, as well as a battery for power.

In FIG. 3, is depicted a mode of the device 10 wherein the media player 18 has been placed in registered engagement within the housing 19 formed from the planar substrate 21. As depicted the media player 18 has a video display 14 in registered positioning for viewing through an opening 27 formed in the assembled housing 19. The media player 18 within the housing 19 may be activated to display video or audio by a distancing of a product package 13 from a resting position 16 on the housing 19 which is marked for easy replacement by a user or viewer.

As noted above, FIG. 3A shows a mode of the device 10 having a cover 31 which when opened will activate the video display 14 much the same as the device as shown in FIG. 10. The device 10, in all modes, includes housing 19 formed of flexible material substrate 21 such as paper, cardboard, plastic or other material which may be printed or otherwise imparted with indicia 25 such as in FIGS. 8-10. The indicia 25 as noted, would be calculated to induce the viewer to open the cover 31 and activate the video screen 14 playing of digital media files stored in memory 28.

The device 10 and method herein using a flexible substrate 21 material adapted for printing or silkscreening, in all modes of the device 10, allows small companies and individuals to employ the system herein and assemble the device 10 from a printable substrate 21, to form the housing 19 for registered engagement with any of a plurality of media players 18 having registerable fasteners 29 adapted to mate with complimentary registerable fasteners 29 on the formed housing 19. Using the recyclable and removable housing 19, a small firm can customize and change each housing 19 and can recycle both the substrate and media player 18 components. The media players 18 may also be provided by a third party, with imprinted housings 19 as requested by a business buyer, and would still be recyclable by removal of the media player 18 for subsequent engagement with a new housing 19, and recycling the substrate 21 forming the current housing 19.

Depicted in FIG. 4, is another mode of the device 10 and system herein showing the planar substrate pre-configured to be folded along creases 33 or the like, to form the housing 19 and which may be printed or otherwise imparted with indicia 25 to induce the viewer to activate the media player 18. As depicted, the media player 18 is positioned for registered engagement within a cavity formed by folding the substrate 21 along the creases 33 and using adhesive areas 41 to hold the substrate 31 folded and defining the internal cavity (not shown). In this mode the media player 18 is surrounded and held in registered positioning within the cavity of the housing 19, registering fasteners in the form of spring or rebounding by biasing tabs 43 defining registering fasteners 29. Once inserted within the cavity formed by the folded and adhered substrate 21, the biasing tabs 43 will contact the four sidewalls of the cavity and hold the media player in registered engagement to position the video display 14 and controls in correct positioning relative to the formed housing 19.

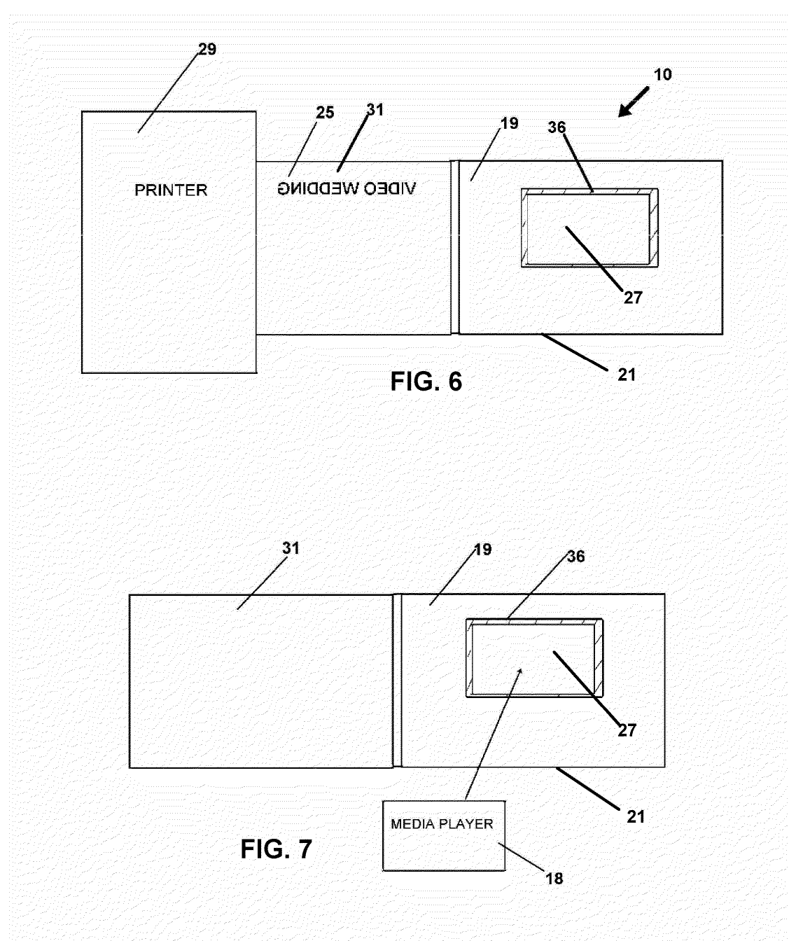

Shown in FIG. 5 is a mode of the device 10 wherein the housing 19 is formed of sufficiently flexible substrate 21 material which is adapted for printing on an inkjet or laser printer as in FIGS. 6 and 8. Also shown are the registering fasteners 29 on both the media player 18 and substrate 21 which engage and hold the media player 18 in registered positioning in the formed housing 19. Any of the noted fasteners herein may be employed however hook and loop fabric would work especially well in this mode.

As shown in FIGS. 6 and 7 the flexible substrate 21, or a templet engageable to a flexible housing 19 substrate 21, can be printed locally or remotely, and then formed to a housing 19. As depicted there is an engagement area 36 formed to engage with a video display if electronics are separately housed in the housing 19. The engagement area 36 can also be recessed or adhesive sized to engage the media player 18 as the registering fastener. In all modes of the device 10 and method, the media player 18 can be self contained within a media housing and engage the formed housing 19 in a mount such as in FIGS. 4-5 for example, or can have electronic components placed within in the housing 19 which are operatively engaged to a video display 14 engaged thereto and held within the opening.

In FIG. 8 can be seen an example of a planar substrate 21 configured with creases 33 for folding to form the housing 19 defining a cavity for a media player 18. Also shown is the method of imparting indicia thereto by a printing device 47 whereafter the planar substrate 21 may be folded and is engageable to any of the media players 18 in a registered positioned engagement using the noted registering fasteners 29 adapted to the task of holding the media player 18 within the formed cavity. As can be discerned the length of the cavity may be determined by the distance between folds 33 as can the width.

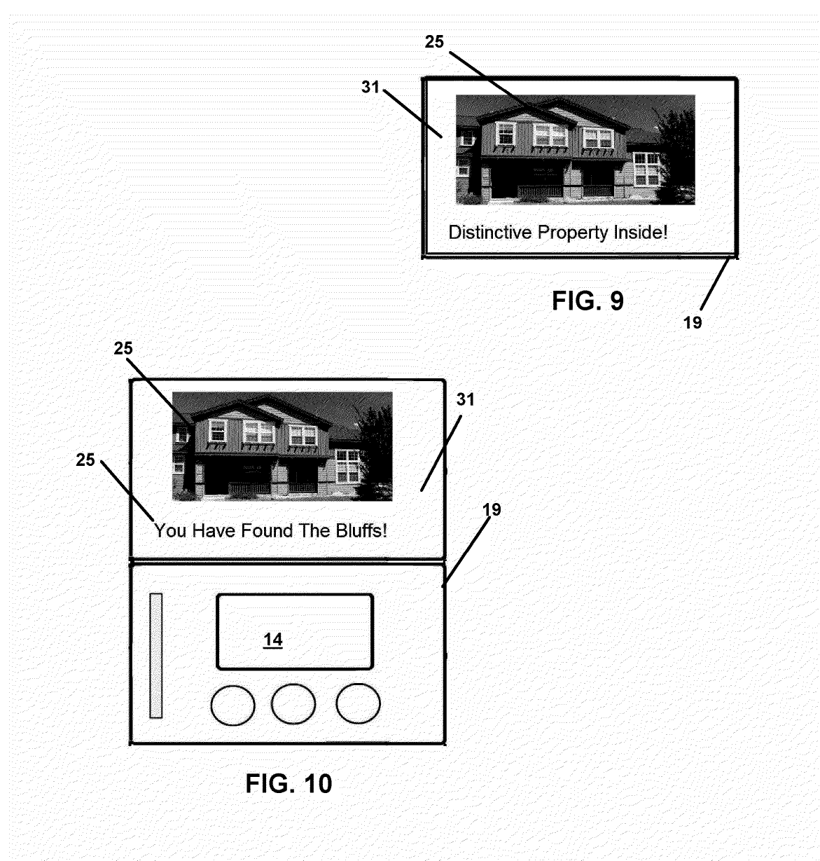

In FIG. 9 is shown a housing 19 formed from a foldable substrate 21, which includes a foldable cover 31 portion folded against the surface of the assembled housing 19. Indicia 25 is positioned thereon using the system shown in FIG. 8.

The device 10 from FIG. 9 is shown in FIG. 10, wherein the cover 31 has been opened as an activation of the media player 18 in registered engagement within the cavity of the housing 19 formed by the planar substrate 21. Additional indicia 25 is shown located on the housing cover interior.

In a method of employment of the system herein, first planar substrates will be formed, in a configuration adapted for folding to yield a housing 19 having an internal cavity adapted to hold a media player 18 therein in a registered engagement. Next, indicia 25 may be imparted to positions on the planar substrate 21 such that the indicia will be viewable on the exterior of the formed housing 19 or any cover therefor. Once the indicia 25 is imparted, the substrate 21 will be folded to form the housing using adhesive or tabs to fix the folded substrates 21 into the form of the housing 19. The media player 18 will be engaged at the appropriate moment during folding of the substrate 21 or through an opening in the formed housing 19, before that opening is sealed. During engagement of the media player 18 with the substrate 21 forming the housing 19, mating fasteners on the substrate 21 will be operatively engaged with such on the media player 18 to hold the media player in registered engagement with the housing 19.

The substrates 21 can be formed to fit any of a plurality of media players 18 and hold such in registered engagements inside a formed housing 18 for use, and can be removed to allow the media player 18 to engage with a subsequent substrate 21 forming a new housing 19. The imprinting of the substrate 21 may be done remotely, whereby the substrates 21 are shipped to the party having the media players 18 which may then be engaged, or the substrates 21 may be imprinted locally. In either fashion, one or a plurality of media players 18 can be operatively engaged with removable and recyclable housings 19 formed of a substrate 21 thereby allowing media players 18 to be reprogrammed and reused by engaging them with new customized housings 19 formed from substrates 21 bearing indicia 25 printed locally, or ordered over a network and shipped to the site of the location of the media players 18 to be engaged.

As noted, any of the different configurations and components can be employed with any other configuration or component shown and described herein. Additionally, while the present invention has been described herein with reference to particular embodiments thereof and steps in the method of configuring the albums to user choices, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A video display comprising:
a planar substrate configurable to a folded configuration defining a housing;
connection areas on said substrate, said connection areas engaging between surfaces of said substrate to maintain said folded configuration;
said housing having an exterior surface defined by walls formed by said folding of said substrate, and having an interior cavity surrounded by said walls;
an opening communicating through one of said walls;
a media player having a display screen for depiction of video thereon;
registering fasteners engaged between said media player and said substrate maintaining said media player within said cavity in a registered positioning, with said display screen viewable through said opening; and
a user activator for activating said media player to depict said video upon said display screen.

2. The video display of claim 1, additionally comprising:
said user activator being an object in a location on or adjacent to said housing; and
a sensor in operative electronic engagement with said media player, said sensor activating said media player when said use moves said object from said location.

3. The video display of claim 1, additionally comprising:
said user activator being a substrate portion in a pivoting engagement at one edge of said housing;
said substrate portion having a first position abutting said opening;
said substrate portion having a second position pivoted away from said opening; and
a pivoting of said substrate portion to said second position, activating said media player.

4. The video display of claim 1, additionally comprising:
said registering fasteners engaged between said media player and said substrate maintaining said media player within said cavity, in a removable said registered positioning; and
said planar substrate being one of a plurality of said planar substrates, each of said plurality having said registering fasteners thereon for achieving a said removable registered positioning with a said media player, whereby said media player is engageable to any of said plurality of planar substrates.

5. The video display of claim 2, additionally comprising:
said registering fasteners engaged between said media player and said substrate maintaining said media player within said cavity, in a removable said registered positioning; and
said planar substrate being one of a plurality of said planar substrates, each of said plurality having said registering fasteners thereon for achieving a said removable registered positioning with a respective said media player, whereby said media player is engageable to any of said plurality of planar substrates.

6. The video display of claim 3, additionally comprising:
said registering fasteners engaged between said media player and said substrate maintaining said media player within said cavity, in a removable said registered positioning; and
said planar substrate being one of a plurality of said planar substrates, each of said plurality having said registering fasteners thereon for achieving a said removable registered positioning with a said media player, whereby said media player is engageable to any of said plurality of planar substrates.

7. The video display of claim 4, additionally comprising:
said plurality of planar substrates, prior to assuming said folded configuration, each having a width adapted for passage through an indicia-imparting component; and
said indicia imparting component placing different appearing indicia upon said exterior surface of each of said plurality of planar substrates, whereby changing a said removable said registered positioning with a said media player, from one substrate of said plurality of planar substrates, to a different respective said substrate from said plurality of substrates, positions said different appearing indicia upon a said housing formed by said respective substrates.

8. The video display of claim 5, additionally comprising:
said plurality of planar substrates, prior to assuming said folded configuration, each having a width adapted for passage through an indicia-imparting component; and
said indicia imparting component placing different appearing indicia upon said exterior surface of each of said plurality of planar substrates, whereby changing a said removable said registered positioning with a said media player, from one substrate of said plurality of planar substrates, to a different respective said substrate from said plurality of substrates, positions said different appearing indicia upon a said housing formed by said respective substrates.

9. The video display of claim 6, additionally comprising:
said plurality of planar substrates, prior to assuming said folded configuration, each having a width adapted for passage through an indicia-imparting component; and
said indicia imparting component placing different appearing indicia upon said exterior surface of each of said plurality of planar substrates, whereby changing a said removable said registered positioning with a said media player, from one substrate of said plurality of planar substrates, to a different respective said substrate from said plurality of substrates, positions said different appearing indicia upon a said housing formed by said respective substrates.

10. A method for forming the video display of claim 1, comprising:
forming said planar substrate with creases configurable to said folded configuration defining said housing;
positioning said connection areas on said substrate, in positions adapted for engaging said surfaces of said substrate to maintain said folded configuration;
imparting indicia to a side of said planar substrate comprising said exterior surface when formed to said housing;
folding said substrate to form said housing;
positioning said media player in said registered positioning;
engaging said registering fasteners between said media player and said substrate to maintain said media player in said registered positioning; and
positioning said user activator to allow a user to activate said media player to depict said video upon said display screen.

11. The method for forming the video display of claim 10 additionally comprising the steps of:
removing said media player said registered positioning;
choosing a second said planar substrate from a group of said planar substrates having said creases configurable to render said substrate to said folded configuration defining a second said housing;
folding said second substrate to form said second housing;
engaging said registering fasteners between said media player and said second substrate to maintain said media player in said registered positioning within said second housing; and
positioning said user activator proximate to said second housing, to allow a user to activate said media player to depict said video upon said display screen.
